(19) United States
(12) Patent Application Publication
(10) Pub. No.: US 2015/0076121 A1
(43) Pub. Date: Mar. 19, 2015

(54) Two-Stage Switch-Mode Power Supply for Drawn-Arc Stud Welding

(71) Applicants: Jeffrey Krupp, Vermillion, OH (US); Larry L. Church, Jefferson, OH (US); Scott J. Schraff, Avon, OH (US)

(72) Inventors: Jeffrey Krupp, Vermillion, OH (US); Larry L. Church, Jefferson, OH (US); Scott J. Schraff, Avon, OH (US)

(21) Appl. No.: 14/541,853

(22) Filed: Nov. 14, 2014

Related U.S. Application Data
(63) Continuation-in-part of application No. 13/231,269, filed on Sep. 13, 2011.

(51) Int. Cl. B23K 9/10; B23K 9/20

(52) U.S. Cl. CPC B23K 9/1043; B23K 9/20
USPC 219/112

(57) ABSTRACT

A drawn arc welding device includes a welding tool, and an energy storage device coupled to a power source. A charging circuit is connected to the energy storage device replenishing the storage device. A discharge circuit is connected to the welding tool and energy storage device. The discharge circuit regulates and adjusts a welding current of the welding tool to a specified amount. Also disclosed is a process that includes charging the energy storage device, actuating the welding tool, energizing a pilot arc current, lifting the weld stud off a workpiece to draw the pilot arc, energizing a welding arc wherein the discharge circuit regulates a welding current of the welding tool to a specified amount, and plunging the weld stud into the workpiece and turning off the discharge circuit.

### CROSS REFERENCE TO RELATED APPLICATIONS

This application is a continuation-in-part of U.S. patent application Ser. No. 13/231,269, flied on Dec. 13, 2011, hereby incorporated by reference.

### FIELD OF THE INVENTION

The invention relates to drawn are welding tools and processes.

### BACKGROUND OF THE INVENTION

Generally drawn are stud welding utilizes stud welding devices that are powered by a three phase 480 volt line power. Such power supplies utilize a three phase industrial power requiring a qualified electrician to connect and disconnect and often requiring crane or forklift operators to relocate them. Additionally, three phase power drops may not be readily available at fabrication shops and repair sites and studs are often welded with inefficient stick welding (SMAW) power sources using available single phase power. Capacitor discharge (CD) stud welding is often powered by domestic single phase supply but CD is restricted to small diameter studs and is not as reliable as drawn-arc stud welding.

There is therefore a need in the art for a drawn arc stud welding power supply that may utilize a single phase domestic line power such as a 115 volt AC in the U.S. or a 230 volt AC in Europe,

There is also a need in the art for a drawn arc stud welder that reduces the input voltage necessary for a drawn arc welding operation. A lower voltage power supply will allow for use in locations where a 3 phase 480 volt or 400 volt industrial power supply is not present. Additionally, there is a need in the art for a drawn arc welding process and power supply providing high quality welds that are easy to inspect and deliver a predictable weld.

Prior art patents associated with welding operations and specifically drawn arc stud welding operations and devices fed by single phase domestic power are deficient for providing a power source in Which a current may be adjustable and regulated. For example, prior art U.S. Pat. No. 7,858,895 discloses a portable drawn arc stud welder with a battery as an energy device. The patent discloses using a battery charger to charge a battery and then uses three MOS FET circuits in parallel to discharge the battery with timer controls to provide a fixed time pulse from 0.1 to 1.1 seconds in duration with current given by output circuit drop (cables, etc.) and battery impedance. However, the prior art patent includes disadvantages in that the welding current may not be adjusted and that the welding current is non-regulated.

Additionally, U.S. Pat. No. 7,183,517 discloses a portable welding-type apparatus that has an energy storage device. The '517 patent discloses a welding power source that includes an energy storage device such as a battery which supplies power to a boost converter linked with a buck converter whose output is then utilized for SMAW, GMAW, GTAW, plasma cutting, and heating. In contrast with a drawn arc stud welding process, the '517 prior art patent requires a boost converter and is configured for other types of high duty cycle welding processes where the welding power is drawn from the energy storage device continuously during welding, typically in minutes per weld. In contrast a drawn arc stud welding has a very low duty cycle, typically in a fraction of a second per weld. Additionally, a drawn arc stud welding process needs a temporary energy storage to accumulate enough energy for a stud welding operation as a typical household line power with a 20 amp service is insufficient in wattage for a typical drawn arc stud welding operation directly without energy storage ahead of welding. The topology disclosed in the '517 prior art patent is intended to utilize current from a low voltage battery continuously While welding thus requiring the boost converter to boost the voltage from the low battery voltage to a higher voltage suitable for use by the various arc welding and cutting processes,

There is therefore a need in the art for an improved drawn arc welding power supply and process that overcomes the deficiencies of the prior art.

### SUMMARY OF THE INVENTION

In one aspect, there is disclosed a drawn arc welding device that includes a welding tool receiving a welding stud. An energy storage device is coupled to a power source. The energy storage device stores energy at a voltage above a welding voltage. A charging circuit is connected to the energy storage device replenishing the storage device. A discharge circuit is connected to the welding tool and energy storage device. The discharge circuit regulates and adjusts a welding current of the welding tool to a specified amount.

In another aspect, there is disclosed a drawn arc welding process that includes the steps of providing a welding tool having a weld stud, providing an energy storage device coupled to a power source, providing a charging circuit connected to the energy storage device, providing a discharge circuit connected to the welding tool and energy storage device, charging the energy storage device, actuating the welding tool, energizing a pilot arc current, lifting the weld stud off a workpiece and drawing the pilot arc, energizing a welding are wherein the discharge circuit regulates a welding current of the welding tool to a specified amount, and plunging the weld stud into the workpiece and turning off the discharge circuit.

In yet another aspect , the drawn arc welding device is provided as a multi-mode device in which the modes are useable selectable by way of a user interface.

In yet another aspect, an icon is disclosed which visually represents the state of the gun and weld output in real time.

### BRIEF DESCRIPTION OF THE DRAWINGS

FIG. 1 is a schematic diagram of one embodiment of a drawn arc welding device;

FIG. 2 is a schematic diagram of an alternative embodiment of a drawn arc welding device;

FIG. 3 is an exploded perspective view of a drawn arc welding device;

FIG. 4 is a flowchart of a process for drawn arc stud welding.

FIG. 5 is a schematic diagram of a second alternate embodiment of the drawn arc welding device illustrated in FIG. 1.

FIG. 6 is schematic diagram of a third alternate embodiment of the drawn arc welding device illustrated in FIG. 1.

FIG. 7 is a simplified exemplary diagram of a control circuit for use with the invention which illustrates the inputs and the outputs to a microprocessor.

FIG. 8 is an exemplary software flow diagram of the power control of a drawn arc welding device as illustrated in FIGS. 5 and 6.

FIG. 9 is an isometric view of an exemplary drawn arc welding device illustrating the user interface.

FIG. 10 is an exemplary view of the various user inputs on the user interface.

FIG. 11A is a table of exemplary factory preset weld settings that can be selected when the user selects the “Preset Values” on the user interface.

FIG. 11B is a table of exemplary stud weld rates

FIG. 12 is a table of pre-programmed weld parameters as a function of the stud specifications Which are used When the stud expert mode is selected on the user interface.

FIG. 13 is a diagram of a weld tool icon that indicates the status of the weld output and the weld tool.

FIG. 14A is a software flow diagram illustrating the operation of the drawn arc welding device.

FIG. 14B is a software flow diagram illustrating the operation of the weld tool icon, illustrated in FIG. 13.

### DETAILED DESCRIPTION OF THE PREFERRED EMBODIMENTS

Various embodiments of the drawn arc welding device are disclosed. Each of these embodiments include a charging circuit, an energy storage system, and a discharge circuit. The charging circuit is connected to an external power source, for example, a single phase, 120 volt, 60 HZ source in the US or a 230 volt, 50 Hz source in Europe. The source may be from a utility power source or a generator.

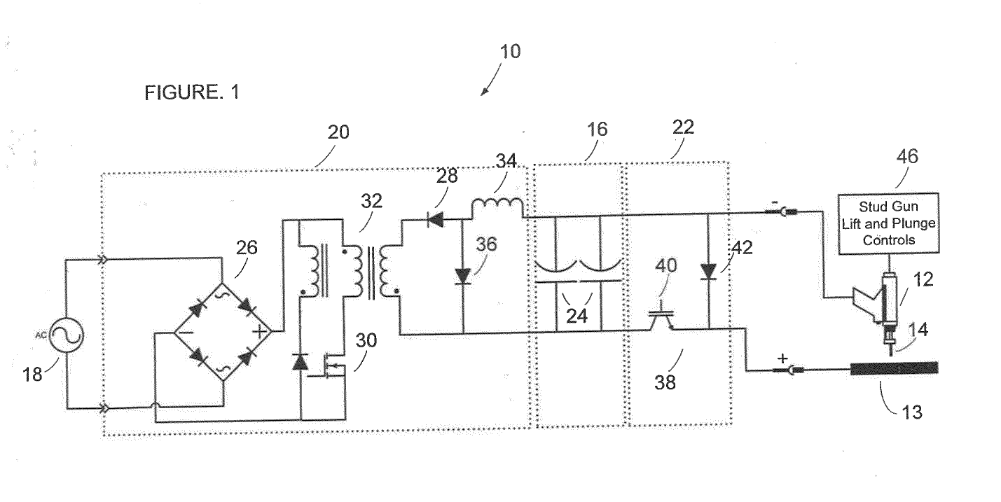

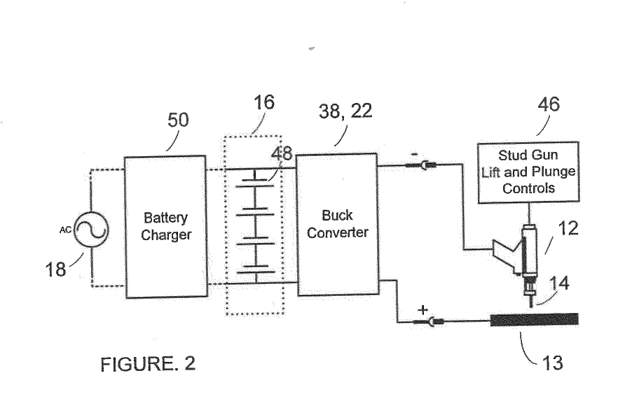

The charging circuit may be a switched mode power supply which provides a regulated voltage to the energy storage system. Such switched mode power supplies include a pass transistor that is switched at a relatively high frequency. FIGS. 1, 5 and 6 illustrate different switched mode power supplies which may be connected to an energy storage system which includes a system of storage capacitors. FIG. 2 illustrates a system in which the energy storage system includes battery cells which are charged by a battery charger. The output of the battery cells are used to perform the welding.

Referring to FIG. 1, there is shown a schematic representation of a drawn are welding device 10 according to one embodiment. The drawn arc welding device 10 includes a welding tool 12 that receives a welding stud 14. The welding device 10 is coupled to a single phase AC input power supply 18. In one aspect, the AC supply 18 is line power or mains from the electricity grid. In another aspect, the AC supply 18 is portable generator. The energy storage device 16 stores energy at a voltage above a welding voltage utilized by the drawn arc welding device 10. A charging circuit 20 is connected to the energy storage device 16 and replenishes the storage device 16. A discharge circuit 22 is connected to the welding tool 12 and energy storage device 16. The discharge circuit 22 regulates and adjusts a welding current of the welding tool 12 to a specified amount and time. In the depicted embodiment of FIG. 1, the energy storage device 16 includes a bank of capacitors 24 that are connected in parallel. The input power 18 includes a household power of 115 volts at 60 hertz in North America and 230 volts at 50 hertz in Europe. The charging circuit 20 in the depicted embodiment includes a full wave bridge rectifier 26 that is output to a forward converter 28. A transistor switch 30 may be utilized to turn on and off at a designated frequency such as at 30 kilohertz. A power transformer 32 may include a turns ratio of 1:2.5 to produce a specified voltage such as 400 volts at the secondary winding. A choke 34 limits the current flow to a high voltage fast rectifier 36. The rectifier 36 is coupled to the energy storage device 16 and stores it at a typical amperage of from 2 to 4 amps. Various drive and control circuits may be utilized in the power circuit to reduce harmonics and noise emission. The voltage in the energy storage device 16 may be monitored such that the transistor switch 30 is turned off when a desired voltage in the energy storage device 16 is reached. While the depicted embodiment details a single ended forward converter 28, various other DC to DC converters may be utilized such as a flyback or SEPIC converter or a converter as shown in U.S. Patent Application Publication 2010/0170880 which is herein incorporated by reference.

In one aspect, the energy storage device 16 retains energy for one stud welding operation. As detailed previously, the depicted embodiment utilizes a capacitor 24 which may be a bank of capacitors 24. In one aspect, the capacitors 24 may have a 200 volt voltage rating and have 27,000 microfarads in capacitance. For a typical drawn arc welding operation for a short cycle welding 3/16 inch insulation pins is 300 amps constant current pulse of 85 milliseconds. With a 40 volt output voltage the required energy is approximately 1020 joules. This output characteristic may be accomplished utilizing two capacitors 24 having a total of 54,000 microfarads in capacitance with 10.9 coulombs of 1080 joule initial stored energy at 200 volts prior to welding. During welding, the buck converter 38 may consume 1040 joules dispensed to the welding are in form of a square wave pulse and in the process of discharging the capacitor bank 24 to 40 volts the capacitor bank 24 retains 43 joules after welding.

A typical weld setting for welding a 5/16 inch diameter stud with a ferrule is 540 amps at 0.25 seconds. Again assuming a 40 volt output voltage, the energy required is 5 kilojoules. This output may be accomplished by utilizing ten capacitors 24 having a 200 volt rating and 27,000 microfarads each with 54 coulombs of full charge and 5½ kilojoules of initial stored energy. During a drawn arc welding process, the buck converter 38 consumes 5.3 kilojoules from the capacitor bank which retains 216 joules at 40 volts. Alternatively, three higher voltage capacitors such as a 370 volt 27,000 microfarad each may also be utilized to accumulate 5.5 kilojoules of initial energy prior to a welding operation.

Again referring to FIG. 1, the drawn arc welding device 10 includes a discharge circuit 22 connected to the welding tool 12 and energy storage device 16. In the depicted embodiment, the discharge circuit 22 includes the buck converter 38. A transistor 40 such as an IGBT module rated at 650 amps switching at 5 kilohertz to 30 kilohertz may be utilized. When the transistor switch 40 is on, the current from the energy storage device 16 is fed to the positive output and provides current to the workpiece 13. The stud welding tool 12 is receiving a stud 14 which through an arc returns to the negative output. A freewheeling rectifier 42 conducts and supplies welding current when the transistor switch 40 is turned off The freewheeling rectifier 42 may be a power diode rated at, for example, 650 amps. The output of the buck converter 38 can be a current pulse of from 60 to 80 volts and having a current of from 300 to 800 amps with various time durations such as from 20 milliseconds to 350 milliseconds in pulse time. In one aspect, a control circuit may be coupled with the discharge circuit 22 that measures the output of the current flowing through the stud welding tool 12 and the arc between the stud welding tool 12. and workpiece 13 and controls through pulse width modulation duty cycle to regulate the output current for a stud welding operation. In one aspect, a control circuit may command a pulse waveform output of the buck converter 38, for example, a peak current of 600 A and background current of 300 A, and peak pulse width of 7 ms and background pulse width of 25 ms.

In one aspect, the circuitry disclosed in the embodiment of FIG, 1 includes a configuration of a straight polarity welding although it should be realized that the stud welding tool 12 and workpiece 13 may be reversed for a reverse polarity that may be utilized for welding aluminum or galvanized steel.

As detailed in FIG. 1, the welding tool 12 may include lift and plunge controls 46. The lift and plunge controls 46 may utilize a drive circuit to control a solenoid for lift using a spring pressure for plunge or may utilize a motor drive to control a motor.

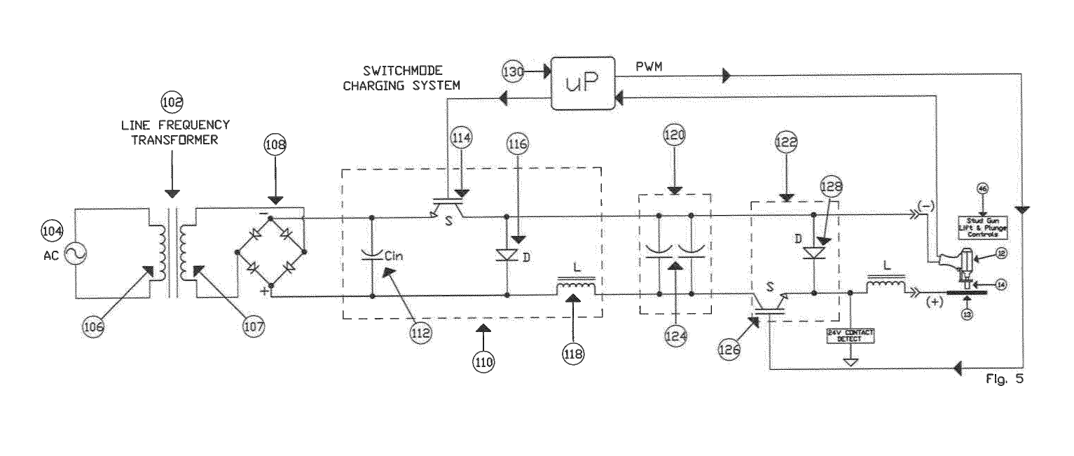

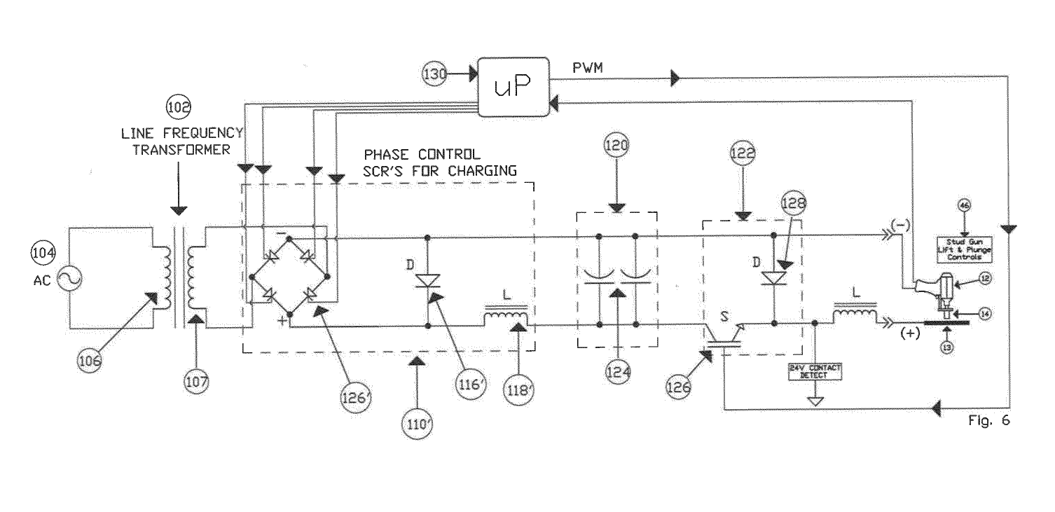

FIGS. 5 and 6 illustrate alternate exemplary charging circuits. These charging circuits have different topologies. Referring first to FIG. 5, the charging circuit 110 is configured as a switched mode power supply, generally identified with the reference numeral 100. This charging circuit 117 includes a line frequency transformer 102. A primary winding 106 of the line frequency transformer 102 is connected to an external AC source 104. The secondary winding 107 of the line frequency transformer 102 is connected to a bridge rectifier 108 which rectifies the AC power from the external AC source 104 and provides a DC signal to the charging circuit 110 that is configured as a switched mode charging system shown within the dashed box 110. In order to smooth out the output of the bridge rectifier 108 , the charging circuit 110 includes a filter capacitor 112. The charging circuit 110 also includes a switch 114, for example, an FET, a free-wheeling diode 116 and an inductor 118.

The system includes a control circuit which includes a microprocessor 130. As will be discussed in more detail below, the control circuit provides multiple operating modes and the ability to independently adjust the charging current and the discharge current.

In accordance with one aspect of the circuit, both the input charging current to the energy storage device 120 as well as the discharge current to the stud welding tool 12 may be varied. Referring first to FIG. 5 Pulse Width Modulation (PWM) pulses, for example, having a frequency of greater than 500 Hz, for example, 2000 Hz, are applied to the gate of the switch 114 from a microprocessor 130. These pulses cause the switch 114 to open and close. During positive half cycles of the PWM pulses, the switch 114 is closed allowing charging current to charge the energy storage device 120. During negative half cycles of the PWM pulses, the switch 114 is open and interrupts the charging current to charge the energy storage device 120.

As will be discussed below, the pulse width of the PWM pulses may be varied manually or automatically to adjust the magnitude of the charging current. In particular, varying the pulse width of the PWM pulses varies the average value and thus the magnitude of the charging current applied to the energy storage device 120.

During positive half cycles When the switch 114 is closed, DC power flows to the energy storage device 120, which may include one or more parallel capacitors 124. During the positive half cycle while the energy storage device 120 is being charged, the inductor 118 smooths out the charging current to the energy storage device 120.

During negative half cycles, when the switch 114 is open, the charging current from the bridge rectifier 108 is abruptly interrupted. Since the current to the inductor 118 cannot safely be interrupted abruptly, a free-wheeling diode 116 provides a current path through the diode 116, the inductor 118 and the energy storage device 120 during half cycles when the switch 114 is open to avoid interrupting the current to the inductor 118.

As mentioned above, the energy storage circuit 120 may include one or more capacitors 124. The charging voltage of the energy storage device 120 may be controlled by a microprocessor 130, as discussed below. The energy storage device 120 feeds a discharge circuit 122. The discharge circuit 122 includes a switch 126 and a diode 128. The diode 128 prevents back feeding of any current from the stud welding tool 12.

The magnitude of the current fed to the stud welding tool 12 or discharge current is controlled by the switch 126 and the microprocessor 130. In particular, the switch 126 is illustrated as a bipolar transistor having a base. The microprocessor 130 controls the switch 126 by way of a Pulse Width Modulation (PWM) signals. By varying the pulse width of the pulses the average value the magnitude of the discharge current can be controlled.

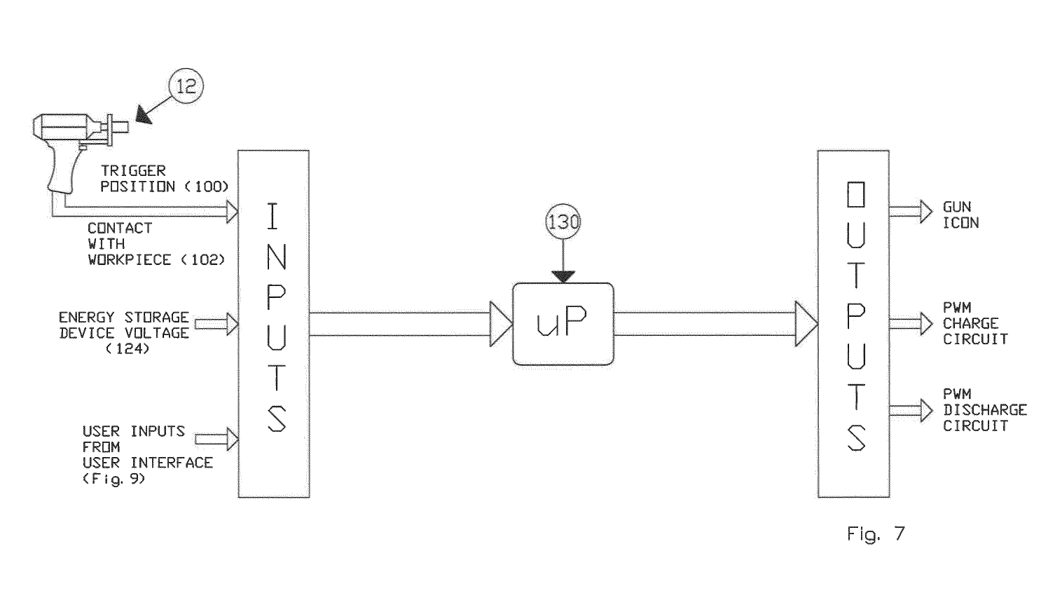

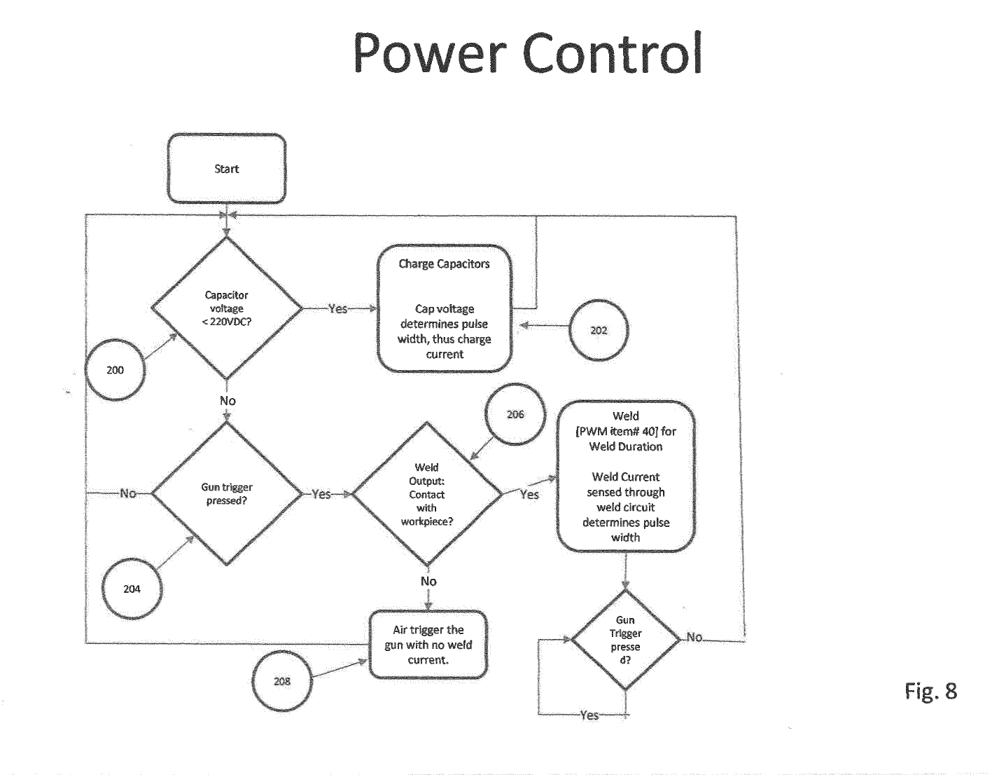

As mentioned above, the microprocessor 130 is used to control the welding process. FIG. 7 illustrates the microprocessor inputs and outputs. FIG. 8 illustrates a software flow diagram for control of the power circuit.

Referring first to FIG. 7, exemplary microprocessor inputs and outputs are illustrated. As shown, several inputs are required from the stud welding tool 12. These inputs include the trigger position 100 and contact with the workpiece 102, The trigger position input 100 is available from a microswitch (not shown) in the stud welding tool 12 that is configured to indicate when the trigger on the stud welding tool 12 is depressed.

Another input from the stud welding tool 12 indicates when the fastener is contact with the workpiece. This signal is generated by a contact detection current limited power supply connected internally to the weld terminals which makes the weld terminal voltage measure ˜24 volts de, A weld voltage measurement is done on the weld terminals. Just prior to a weld, the operator will press the stud down to the workpiece, which shorts the contact detection power supply. When the microcontroller 130 senses the weld terminal voltage go below a threshold voltage, it indicates ‘contact present’. As shown in both FIGS. 5 and 6, the microprocessor 130 monitors the voltage at the weld tool.

The microprocessor 130 also monitors the voltage 104 of the capacitors 124 in the energy storage device 120. Welding is only initiated when the capacitors 124 are fully charged. This condition is determined when the capacitors have reached a nominal voltage, for example, 220 volts.

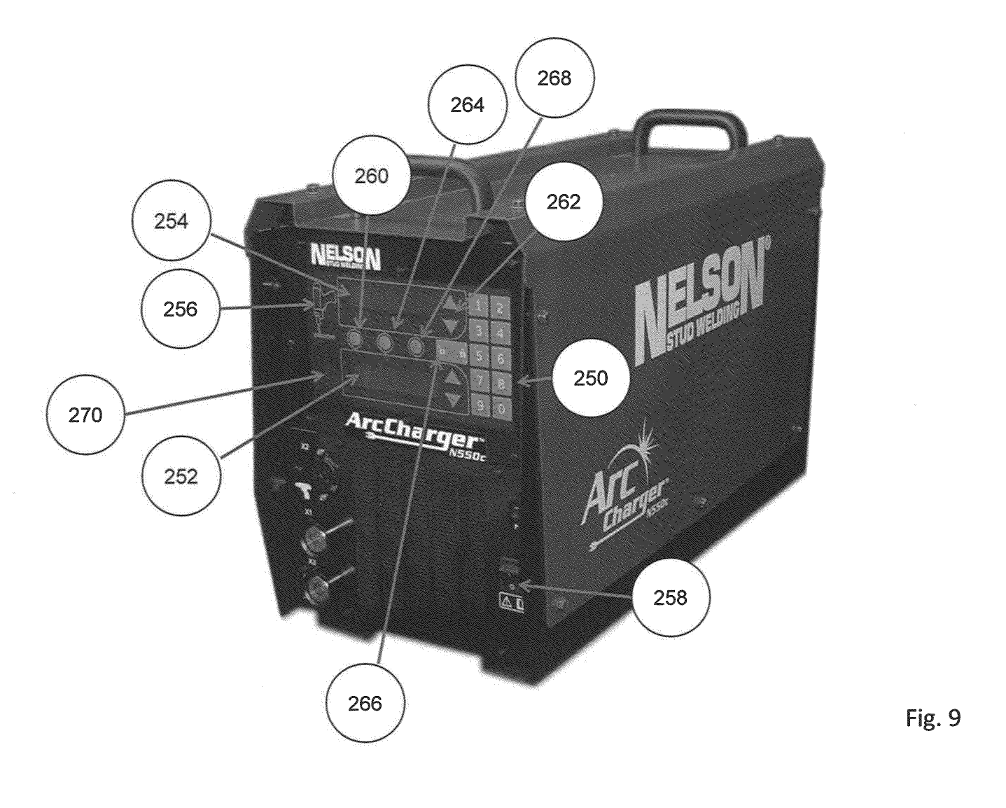

As will be discussed in detail below, the microprocessor 130 also monitors the user interface illustrated in FIG. 9 to respond to the various user inputs 106 at the user interface. These inputs are processed by the microprocessor 130 in order to provide control of the welding process. Exemplary outputs from the microprocessor 130 include the pulse width of the pulses feeding the switch 114 (FIG. 5) as well as the pulse widths that determine the magnitude of the discharge current. The microprocessor 130 also controls the operation of the tool icon.

Referring to FIG. 8, a software flow diagram illustrates the logic associated with the power control of the weld process. More particularly, in step 200, the system checks the voltage of the capacitors 124 in the energy storage device 120 to determine if the capacitors 124 are fully charged, i.e. capacitor voltage greater than a nominal voltage, for example, 220 volts DC. If not, the system proceeds to step 202 and automatically adjusts the pulse width of the charging current. This is done by the microprocessor 130 (FIG. 5) which adjusts the pulse widths of the PWM pulses applied to the gate of charging current switch 114. In order to speed up the charging of the capacitors 124, the pulse widths of the PWM pulses are increased in order to increase the average value and thus the magnitude of the charging current.

The systems continuously loops back to step 200 to continuously check the voltage of the capacitors 124. Once the capacitors 124 reach the nominal voltage, as determined in step 200, the system checks in step 204 whether the gun trigger is depressed. If not, the system loops back to step 200 and monitors the voltage of the capacitors 124 (FIG. 5). Once gun trigger is pressed and the capacitors 124 are fully charged, the system determines whether there has been contact with the work piece in step 206. If not, the system assumes an “air trigger” event in step 208 and keeps the discharge switch 126 in an off position and returns to step 200 and monitors the voltage of the capacitors 124 (FIG. 5).

If contact with the workpiece is sensed in step 206, the microprocessor 130 sets the pulse width of the PWM current pulses to the achieve the desired discharge current. As will be discussed in more detail below, the discharge current is set in various ways.

Referring to FIG. 6, an alternate embodiment of the charging circuit is illustrated. In this embodiment, an alternate charging circuit 110′ is provided. The charging circuit 110′ includes a bridge rectifier 126′ formed from silicon controlled rectifiers (SCR). The gates of the SCRs are all tied to microprocessor 130 which controls the SCRs to function in a manner similar to a bridge diode rectifier, i.e. convert the AC from the transformer 102 to DC. SCRs are normally used for high current applications and can be switched on and off Such SCRs are turned on by applying a positive pulse to its gate 134 and turned off by commutating off More particularly, SCR's are triggered on during a portion of an AC half-cycle by the microprocessor 130. The SCRs will latch and remain on throughout the remainder of the half-cycle until the AC current decreases to zero, as it must to begin the next half cycle. Just prior to the zero-crossover point of the current waveform, the SCR will turn off due to insufficient current, known as natural commutation, and must be fired again during the next cycle. The result is a circuit current equivalent to a “chopped up” sine wave. An inductor 118′ may be provided to smooth out the current. A free-wheeling diode 116′ may be provided to provide a current path during off times of the SCRs.

The microprocessor 130 also monitors the voltage of the energy storage device 120. In particular, the microprocessor 130 signals the gate 134 of the SCR 132 to open and therefore disconnect power to the energy storage device 120 when the energy storage device 120 is fully charged.

The microprocessor 130 controls the pulse width of the current pulses applied by the bridge 126′ to the charging circuit 120. As discussed above, the pulse widths of the current pulses determine the average value and thus the magnitude of the discharge current. Control of the pulse widths of the current pulses applied to the charging circuit 120 allows the input current to the charging circuit to be adjusted.

Referring to FIG. 2, there is shown an alternative embodiment of a drawn arc welding device 10. In the depicted embodiment of FIG. 2, the drawn arc welding device 10 may be utilized for multiple welds after a single charge as opposed to the capacitors 24 of the first embodiment. In the alternative embodiment the energy storage device 16 may include at least one battery 48 and in one aspect a plurality of batteries 48 coupled in a bank. It should be realized that various batteries 48 may be utilized such as motorcycle batteries, car batteries, and heavy duty off road equipment or marine batteries. In one aspect, motorcycle batteries may be utilized for short cycle and pin type welds. Twelve volt car batteries may be utilized for studs ranging in size up to ½ inch while heavy duty or marine batteries may be used for ⅝″ and larger diameter studs. For example, six 12 volt car batteries connected in series may have a supply of 72 volts to the buck converter. Including a switch loss of 2 volts, the batteries provide 70 volts output voltage for welding such that a full charge of a battery may be utilized to weld up to 400 CPL studs of ½ inch stud diameter. As presented above with respect to the embodiment of FIG. 1, the AC power supply 18 is preferably a single phase household line power of either 115 volts at 60 hertz or 230 volts at 50 hertz that is connected to a battery charger 50. In another aspect, the AC supply 18 is portable generator providing household power. The battery charger 50 in turn is coupled to the at least one battery or bank of batteries 48 which is linked to the buck converter 38 of the discharge circuit 22. As previously described above, the discharge circuit or buck converter 38 regulates and adjusts a current of the welding tool 12 to a specified amount.

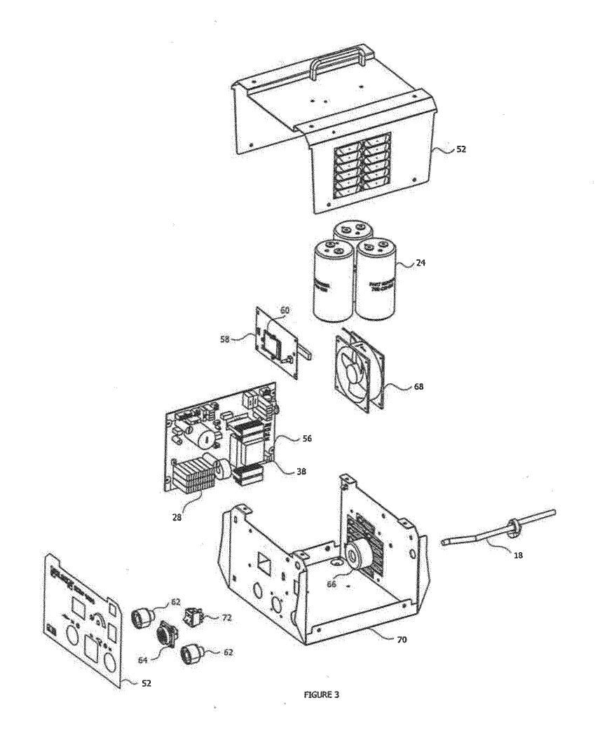

Referring to FIG. 3, there is shown one embodiment of a power supply and control that is connected to the welding tool 12. In one aspect, the depicted embodiment includes a cover 52 and chassis 70 that house energy storage capacitors depicted at 24. Printed circuit boards 56 include power electronics for the forward converter charge circuit 28 and the discharge or buck converter circuit 38. A PC board 58 may be utilized for control circuitry for a gun solenoid or motor controls as well as to turn off and on the charge circuit 28 as well as monitor and shut off charging. Additionally, the PC board 58 may include a closed loop current regulation of the buck converter 38 and user interface 60 that has a display allowing changes and adjustments in parameters of the welding operation such as the current and time of the weld. The output of the buck converter 38 is provided at two terminals 62 with an additional connector 64 for control of the stud welding tool 12. Additionally, a fan and transformer 66, 68 may he utilized to provide auxiliary power to the PC boards. Power line cord 18 may he connected to a household power drawing a typical household amperage and having 115 volts or 230 volts, as disclosed above. An on/off switch 72 may be utilized to turn the power supply on and off.

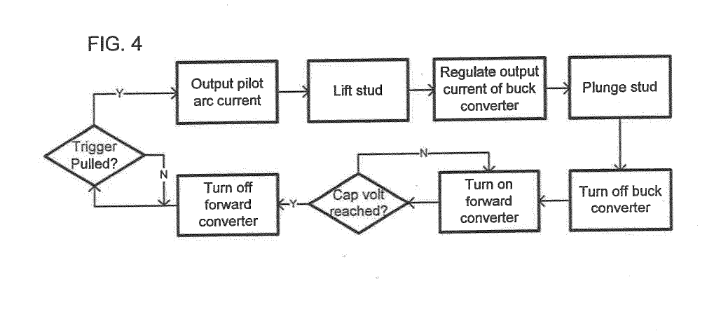

In another aspect, there is disclosed a process for stud welding or drawn arc welding that includes the steps of providing a welding tool 12 having a welding stud 14, providing an energy storage device 16 coupled to an input power source 18, providing a charging circuit 20 connected to the energy storage device 16, providing a discharge circuit 22 connected to the welding tool 12 and energy storage device 16, charging the energy storage device 16, actuating the welding tool 12, energizing a pilot arc current through the short circuit between a stud and a workpiece 13, lifting the weld stud 12 off a workpiece 13 drawing the pilot arc, energizing a welding arc wherein the discharge circuit 22 regulates and adjusts a welding current of the welding tool 12 to a specified amount, and plunging the weld stud 14 into the workpiece 13 forming a weld and turning off the discharge circuit 22. Referring to FIG. 4, there is shown a flow chart of the process. Following an actuation of the welding tool 12, the control circuitry 58 commands the output of a pilot arc current that is lower than a welding current. The control circuit 58 then commands the lift of a stud 14 to a solenoid or motor in the welding device 12. After the stud 14 is lifted, a closed loop feedback control of a buck converter 38 current output is performed by sending appropriate pulse width modulation for a specified time duration. Next the control circuit 58 instructs the welding tool 12 to plunge a stud 14 and turn off the buck converter 38, Next the energy storage device 16 is replenished until a prescribed energy level is reached awaiting the next actuation of the welding tool 12. In one aspect, the control circuitry 58 of the welding device 10 may be accomplished utilizing various circuitry preferably including microprocessor. The operating sequence may include the following steps. The welding device 10 includes a chuck that holds the stud 14 and pushes the stud 14 against a workpiece 13 creating a short circuit between the stud 14 and workpiece 13. Before a welding operation is performed the charge circuit 20 charges the energy storage device 16. Following actuation of the welding tool 12, the buck converter 38 of the discharge circuit 22 delivers a small pilot arc typically at a current of from 25 amps to the short circuit. After about 5 milliseconds the welding tool 12 lifts the stud 14 drawing an arc at 25 amps. Due to the sudden load increase from the arc voltage, pulse width modulation pulse width to the transistor 30 is increased. The control circuitry 58 of the welding device will then further increase the pulse width to output a desired welding current such as at 300 amps for a fixed duration for such time as 85 milliseconds. The control circuit 58 will then plunge the stud 14 towards the workpiece 13 as the arc is terminated. Pulses to the transistor 30 will stop thus turning off the buck converter 38. At this time the forward converter 28 is turned on to recharge the capacitor bank or capacitor 24 in the first embodiment. Alternatively, the pilot arc may be supplied by an auxiliary power supply connected in parallel with the buck converter 38. In one aspect, a power MOSFET or SCR. bridge may be connected in series with a current limiting resistor across an IGBT.

As previously stated above, charging of the energy storage device 16 preferably includes charging the energy storage device 16 to a voltage above a welding voltage. Additionally, energy stored in the energy storage device 16 such as in the first embodiment is preferably greater than 1000 joules. Additionally, capacitors 24 associated with the first embodiment may include a capacitance greater than 27,000 microfarads. Further, with respect to the second embodiment, the energy storage device or battery 48 preferably has an output voltage greater than 48 volts.

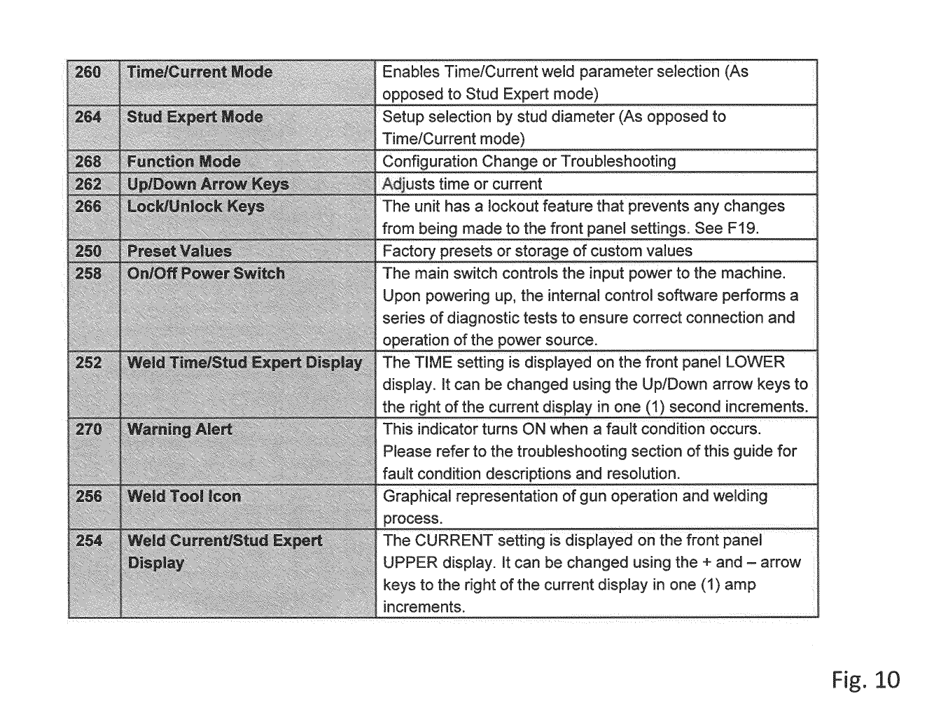

An exemplary view of the user interface for the device is illustrated in FIG. 9 and described in FIG. 10. The interface may include various pushbuttons, identified generally with the reference numeral 250, one or more displays 252, 254 and a multi-stage icon 256. The interface includes an on/off switch 258 and a lock/unlock key 266. When the lock/unlock key 266 is in a locked mode, the microprocessor 130 ignores all subsequent entries to the interface until the lock/unlock key 266 is in an unlocked mode.

The user interface enables multiple mode operation of the device to be selected. These modes include:

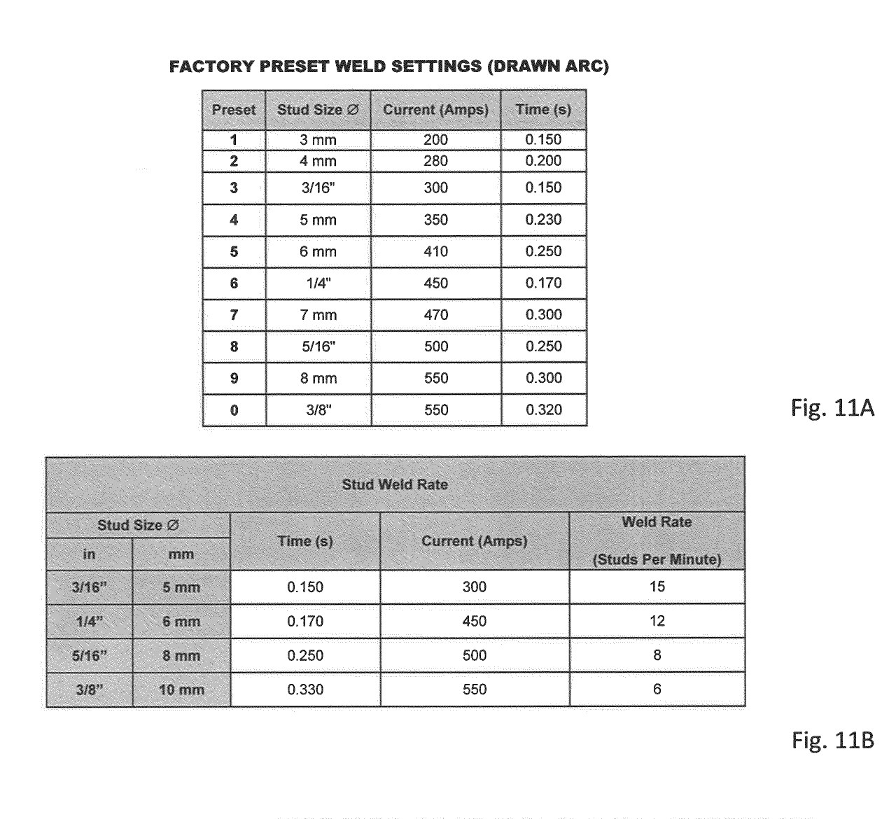

Time Current Mode: In this mode, the weld time and weld current are set manually. More specifically , a user selects a “Time/Current Mode” switch 260. This enables a user to manually set the weld time by way of the up/down arrows 262. The selected values are “read” by the microprocessor 130 which adjusts the discharge current as discussed above. The weld time may also be adjusted by the microprocessor 130. The microprocessor 130 can adjust the length of time that the PWM pulses are supplied to the stud welding tool 12 after contact with the workpiece. Exemplary weld times and. weld currents as a function of fastener diameter are illustrated in FIG. 11B.

Factory Preset Mode: In this mode, the user selects one of the pushbuttons 250 that are identified with the numbers 0-9. Exemplary preset weld settings are illustrated in FIG. 11A. These preset weld settings are provided as a function of fasteners of different diameters. Based on the selected setting, the microprocessor 130 reads the selected setting and adjusts the weld current and weld time as discussed above.

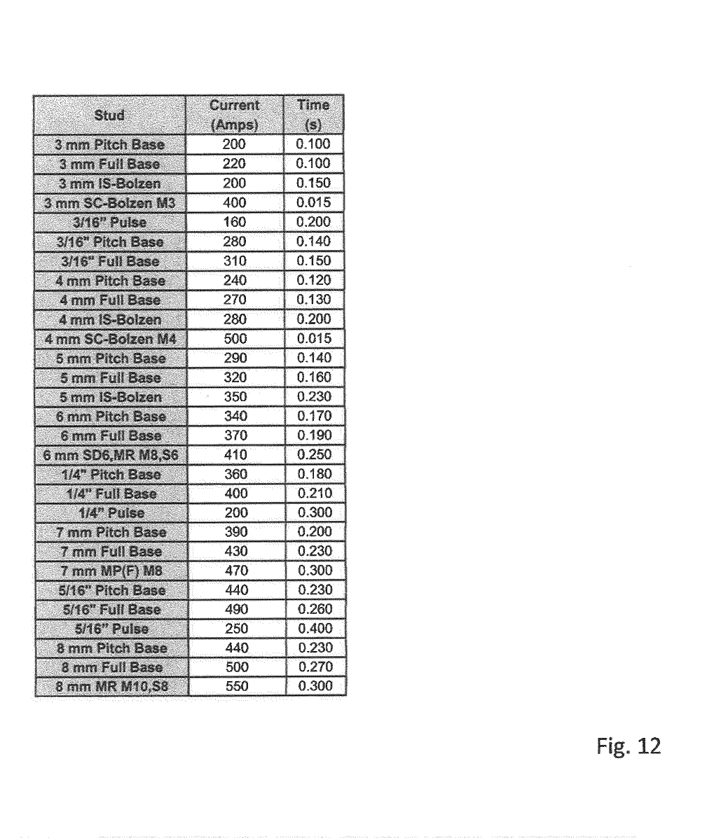

Expert Mode: In this mode , the user selects the button 264. When the expert mode is selected, exemplary weld current and weld time settings are displayed on the displays 254 and 252, respectively. Exemplary values for the weld current and the weld time are illustrated in FIG. 12, These values can be stored in a look-up table or calculated by the microprocessor 130 based upon the diameter of the fastener. These values can be adjusted up or down. In particular, the weld current values can be adjusted by the up/down arrows adjacent the weld current display 254. The weld time values can be adjusted by the up/down arrows adjacent the weld time display 252.

The user interface may also include a function mode key 268. This function mode key 268 may be used for a configuration change, such as changing a previously configured weld time and weld current.

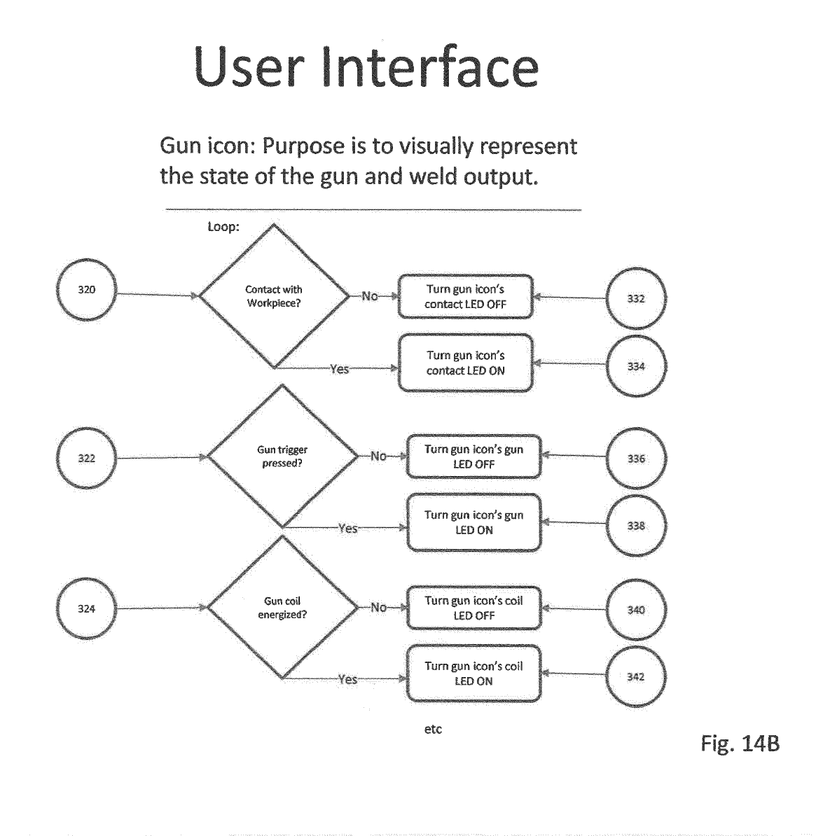

FIG. 14A is a software flow chart illustrating the operation of the user interface. Initially, the system waits for the selection of one of the three modes discussed above. The time current mode is identified within the decision block 300. The Expert mode is identified within the decision block 302. The Factory Preset Mode is identified within the decision block 304.

When the Time/Current mode is selected, the microprocessor 130 reads the selected time and current values from the interface and adjusts the weld time and pulse width of the discharge current values accordingly in step 306. When the expert mode is selected the microprocessor 130 reads the selected stud diameter and calculates or looks up the corresponding weld times and weld current values and adjusts weld time and pulse width of the discharge current values accordingly in step 308. If the user selects the factory preset mode, the microprocessor 130 reads the selected weld times and weld current values and adjusts weld time and pulse width of the discharge current values accordingly in step 310.

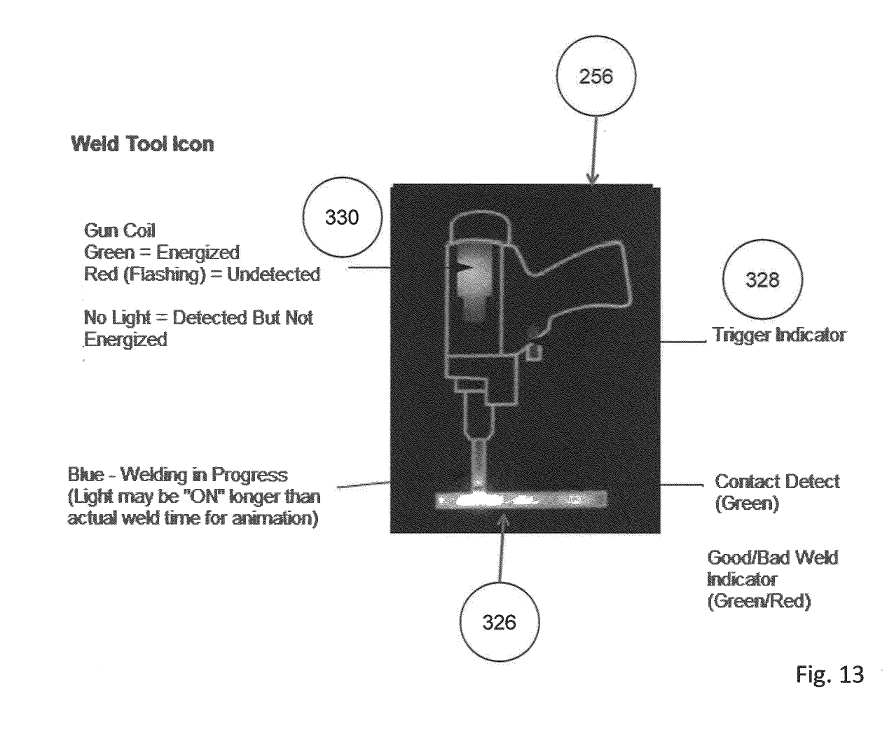

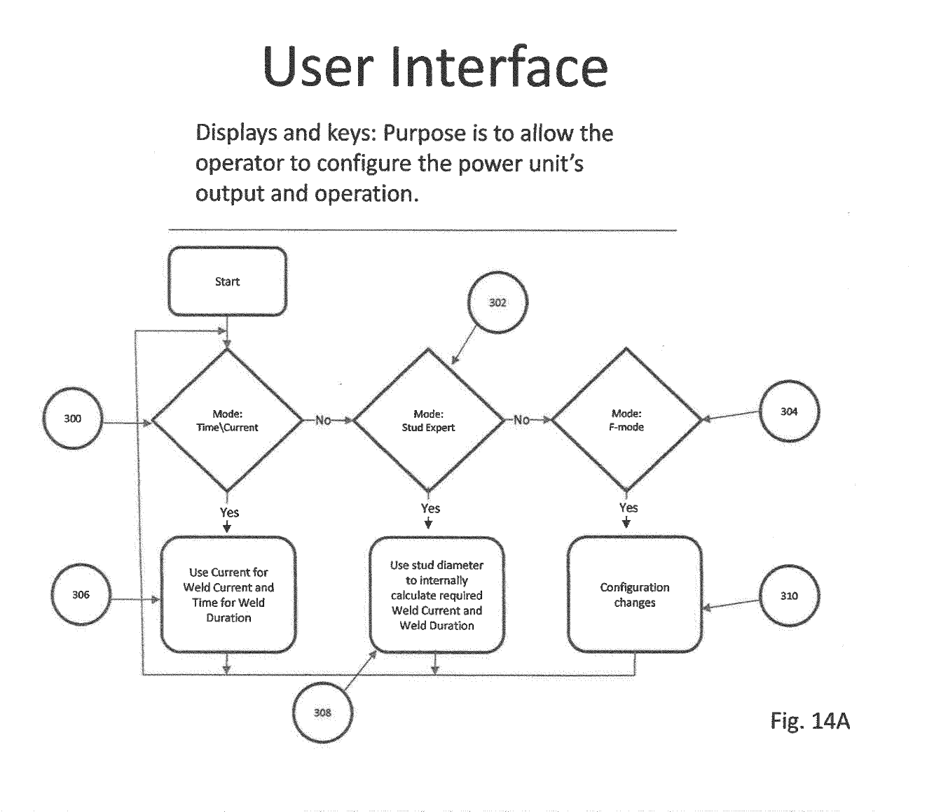

Another aspect of the device is a multi-stage weld tool icon that visually represents the status of the gun and the weld output in real time. An exemplary representation of the weld tool icon 256 is illustrated in FIG. 13. The icon 256 is displayed as a profile of a weld tool with various portions of the icon backlit with LEDs to provide a visual indication of the state of the weld tool, and the weld output. Specifically, the icon provides an indication of:

Whether there was contact with the work piece as determined by the decision block 320 (FIG. 14B)

Whether the gun trigger was pressed as determined by the decision block 322

Whether the gun coil is energized as determined by the decision block 324

When a fastener is in contact with a workpiece is detected, an LED (not shown) backlights a workpiece portion 326 (FIG. 13) of the icon 256 to indicate the status of the weld. The LED may be an Red/Green/Blue (RGB) LED or three separate LEDs. This LED may be used to indicate three (3) separate states of the weld process.

Contact with the workpiece—Green: The generation of this signal is discussed above.

Welding in Progress—Blue This signal is generated by a combination of signals the operator depressing the trigger, generated by the trigger microswitch discussed above+the capacitors being fully charged as measured by the microcontroller 130+contact with the workpiece as discussed above.

Good/Bad weld indicator-Green/Red: In order to generate this signal the system, the system stores the weld current, weld voltage and weld time for each weld. After a good weld, the user can select the “Function Mode” button 268 on the user interface (FIGS. 9 and 10) and select a “Weld Results” function, which displays the stored values for the last weld. The user may then depress the “Lock” key 266 to save the displayed values. The system uses these values along with the tolerances discussed below to indicate the quality of a weld, as discussed below. The system may have factory default tolerances or alternatively the user can select the “Function Mode” button 268 and select a “Tolerances” function. The user can then set the tolerances by way of the user interface in order to set tolerances for the parameters set forth above. The “Lock” key 266 may be used to save the selected tolerances. With the parameters and tolerances set, subsequent welds that fall within the tolerances of the parameters are indicated to be a good weld. Subsequent welds that fall outside the tolerances of the parameters are set selecting the function mode key

In particular, the RGB LED may be controlled to illuminate a green color when a fastener is in contact with the workpiece. When the welding process is in progress, the RGB LED may be controlled to illuminate a blue color. After the weld is complete, the ROB LED may be controlled to illuminate a green color for a good weld and a red color for a bad weld.

The icon 256 may also be used to provide a visual indication of the state of stud welding tool. In particular, the status of the gun trigger may be indicated by an LED (not shown) that illuminates the gun trigger 328 when it is pressed.

The icon 256 may also be used to provide an indication of the state of the tool 12. In particular, a Red/Green (RO) LED (not shown) may be used for this purpose. This LED may be controlled to illuminate the gun coil 330 with a green color when the gun coil is energized. This signal may be generated by the microswitch (not shown) When the gun trigger is depressed. The LED may be controlled to flash red when the gun coil is undetected. This signal may be generated When the microprocessor 130 (FIGS. 5 and 6) detects relatively low current through the gun coil, for example ≦10 milliamps. Finally, when the gun coil is detected but not energized, the LED off, This signal may be generated by the microswitch (not shown) when the gun trigger is depressed in combination with current >10 milliamps in the gun coil.

A software flow diagram for the tool icon is illustrated in FIG. 14B. The microprocessor 130 determines whether:

the fastener is in contact with the workpiece, as indicated by the decision block 320;

the status of the gun trigger, as indicated by the decision block 322; and

the status of the gun coil, as indicated by the decision block 324.

If the microprocessor 130 determines that the fastener is in contact with a workpiece, the LED is turned on, as discussed above, as indicated in step 332, If the microprocessor 130 determines that the fastener is not in contact with a workpiece, the LED is turned off, as discussed above, as indicated in step 334.

If the microprocessor 130 determines that the gun trigger is pressed, the LED is turned on as discussed above, as indicated in step 336. If the microprocessor 130 determines that the gun trigger was not pressed, the LED is turned off, as discussed above, as indicated in step 338.

If the microprocessor 130 determines that the gun coil is energized, the LED is turned on, as discussed above, as indicated in step 340. If the microprocessor 130 determines that the gun coil is not energized, the LED is turned off, as discussed above, as indicated in step 342.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

We claim:

1. A drawn arc fastener welding device comprising:
a charging circuit configured to be connected to an external single phase source;
an energy storage device coupled to a power supply;
a discharge circuit connected to said energy storage device and configured to be connected to a welding tool;
a control circuit which includes a user interface that enables multiple user selectable modes of operation.

2. The welding device as recited in claim 1 wherein said multiple modes of operation includes a time-current mode of operation.

3. The welding device as recited in claim 1, wherein said multiple modes of operation includes a factory preset mode of operation.

4. The welding device as recited in claim 1, wherein said multiple modes of operation includes an expert mode of operation.

5. The welding device as recited in claim 1, wherein said charging current is user selectable.

6. The welding device as recited in claim 1, wherein said discharge current is user selectable.

7. The welding device as recited in claim 2, further including a user interface that enables said weld current to be adjusted.

8. The welding device as recited in claim 2, further including a. user interface that enables said weld time to be adjusted.

9. The welding device as recited in claim 1, further including an icon that displays the status of the weld output in real time.

10. The welding device as recited in claim 1, further including an icon that displays the status of the tool in real time.

11. The welding device as recited in claim 1, wherein said multiple. modes are user selectable.
